(19) United States
(12) Patent Application Publication
(10) Pub. No.: US 2012/0090638 A1
(43) Pub. Date: Apr. 19, 2012

(54) METHOD FOR OPERATION OF AN AUTOMATIC DISHWASHER

(76) Inventors: Arnd Kessler, Monheim am Rhein (DE); Thorsten Bastigkeit, Wuppertal (DE); Christian Nitsch, Dusseldorf (DE); Wolfgang Wick, Dormagen (DE); Karl-Heinz Hohenadel, Langenfeld (DE)

(21) Appl. No.: 13/330,770

(22) Filed: Dec. 20, 2011

Related U.S. Application Data
(63) Continuation of application No. PCT/EP2010/059002, filed on Jun. 24, 2010.

(30) Foreign Application Priority Data
Jul. 1, 2009 (DE) 10 2009 031 433.4

(51) Int. Cl. B08B 7/04; B08B 3/08

(52) U.S. Cl. 134/18

(57) ABSTRACT

A method for operating an automatic dishwasher is disclosed. Provided are a dispenser, a cartridge with a chamber of rinse aid, a washing program including a cleaning program, and a sensor for measuring soil on the dishware or in the wash. The soiling is compared to a reference value and if less than reference, the temperature of the wash is held to ≦65° C., and at the end of the cleaning program and/or the intermediate rinse cycle, rinse aid is dispensed and drying immediately follows the cleaning program and/or intermediate rinse cycle without execution of a rinse aid program.

### CROSS-REFERENCES TO RELATED APPLICATIONS

This application is a continuation of PCT Application Serial No. PCT/EP2010/059002, filed on Jun. 24, 2010, which claims priority under 35 U.S.C. §119 to 10 2009 031 433.4 (DE), filed on Jul. 1, 2009. The disclosures PCT/EP2010/059002 and DE 10 2009 031 433.4 are hereby incorporated by reference in their entirety.

### FIELD OF THE INVENTION

The present invention generally relates to a method for operating an automatic dishwasher, in particular a dishwasher having a dispenser that may be positioned within the interior of the dishwasher, having a cartridge that comprises a plurality of chambers, at least one of the chambers encompassing a rinse aid preparation.

### BACKGROUND OF THE INVENTION

As a result of constantly rising prices for energy, water, and raw materials, efforts have been underway for some time to embody water-conveying household appliances, for example dishwashers, in as energy- and/or water-conserving a manner as possible.

Dishwashers are usually controlled by washing programs that represent a sequence over time of specific washing segments, such as e.g. a pre-wash program (VS), cleaning program (RG), intermediate rinse program (ZG), rinse aid program (KS), and drying program (TR).

Depending on the degree of soiling, the user of a dishwasher can manually select a washing program from a number of washing programs stored in the dishwasher, or the dishwasher automatically selects a washing program in accordance with the degree of soiling and/or loading status of the dishwasher. Turbidity sensors and loading sensors are usually utilized for this purpose in a dishwasher.

One of the most energy-intensive program steps in a washing program is the rinse aid program (KS) and/or the drying program (TR). It is therefore desirable to configure this/these program step(s) to be as energy-conserving and energy-efficient as possible.

A further trend that may be observed is that the items to be washed now often exhibit only a comparatively low degree of soiling; this can be explained by, among other factors, the fact that consumers are turning to so-called “convenience foods,” in which a pre-cooked meal is prepared in the product package, so that, for example, heavy soiling in pots or pans occurs less often.

Accordingly, it is desirable to make available an energy-optimized washing program for a dishwasher, in particular for washing lightly soiled items. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

This object is achieved by a method for operating a dishwasher having the features of Claim 1.

The present invention is a method for operating an automatic dishwasher, said method comprising the steps of:
a. providing a dispenser permanently installed in the dishwasher or movably positioned in the interior of the dishwasher, said dispensing having a cartridge comprising a plurality of chambers, each of said chambers containing different preparations, wherein at least one of the chambers includes a liquid rinse aid preparation;
b. providing a program control system for controlling the dishwasher, wherein at least one washing program comprises: a cleaning program (RG); an intermediate rinse program (ZG); a drying program (TR); a rinse aid program (KS); and optionally, a pre-wash program (VS);
c. providing at least one sensor for determining the degree of soiling on the items to be washed or the degree of soiling in the washing water present in the dishwasher;
d. determining the degree of soiling VG at least once at the beginning of the washing program at a point in time t₁;
e. comparing the measured degree of soiling VG with a reference value R_{w1} that represents a slight soiling of the items to be washed and/or slight soiling in the washing water present in the dishwasher; and wherein if the degree of soiling VG is less than or equal to said reference value R_{w1}, then:
   i. holding the temperature of the washing water at least during the cleaning program (RG) on average at ≦65° C.;
   ii. delivering said liquid rinse aid preparation from the dispenser into the interior of the dishwasher at the end of the cleaning program (RG) and/or at the end of the intermediate rinse cycle (ZG); and
   iii. executing the drying program (TR) immediately following the cleaning program (RG) and/or the intermediate rinse cycle (ZG) without execution of the rinse aid program (KS).

### BRIEF DESCRIPTION OF THE DRAWINGS

The present invention will hereinafter be described in conjunction with the following drawing figures, wherein like numerals denote like elements, and:

FIG. 1 illustrates a schematic washing program sequence in accordance with the prior art;

FIG. 2 illustrates a schematic washing program sequence with rinse aid release in the cleaning program;

FIG. 3. illustrates a schematic washing program sequence with rinse aid release in the final intermediate rinse step; and

FIG. 4 illustrates a method configuration for operation of the dishwasher.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The fact that rinse aid is metered in already in the cleaning and/or intermediate rinse program of a washing program for lightly soiled items to be washed allows good drying performance to be achieved even if the rinse aid program is omitted, and with lower temperatures in the drying program.

What occurs here in particular, is that the heat content of the items to be washed is utilized, the items to be washed usually being approximately at the temperature of the washing water. The heat content of the items to be washed is thus not extracted by the fresh (and usually cold) washing water introduced by the rinse aid program, but instead remains in the dishwasher.

The elevated temperature of the items to be washed at the end of the cleaning program results, in combination with the fact that the surfaces of the items to be washed are wetted with rinse aid preparation at the end of the cleaning program, in sufficiently good drying of the items to be washed, with no need, in the drying program, for an excessive increase in the temperature in the dishwasher above the temperature of the washing water. This furthermore makes it possible to shorten the duration of the drying program, which is advantageous in particular for short washing programs.

It is further advantageous to provide a dosage of the rinse aid preparation at a washing-water temperature in the cleaning program of ≦65° C., since foaming of the rinse aid preparation is largely avoided at these temperatures.

The method according to the present invention includes a dispenser having a cartridge comprising a plurality of chambers, the chambers each containing preparations that differ from one another and wherein at least one of the chambers holds a liquid rinse aid preparation.

The method further comprises a program control system for controlling the dishwasher, in which is provided at least one washing program made up of a cleaning program (RG) as well as optionally a pre-wash program (VS) and/or intermediate rinse program (ZG) and/or rinse aid program KS) and/or drying program (TR). The program control system can be provided in the dispenser and/or in the dishwasher.

At least one sensor for determining the degree of soiling of the items to be washed and/or washing water present in the dishwasher is also provided. According to a preferred embodiment of the invention, the sensor used for determining the degree of soiling is a turbidity sensor. The sensor for determining the degree of soiling can be placed in the dispenser and/or in the dishwasher.

By means of the sensor for determining the degree of soiling, the degree of soiling VG is determined at least once, at the beginning of a washing program at a point in time t₁, t₁ preferably being before or at the beginning of the cleaning program (RG). “At the beginning of the cleaning program” means that the measurement occurs in the first third of the cleaning program with respect to its sequence over time.

The degree of soiling VG measured by means of the sensor for determining the degree of soiling is then compared with a reference value R_{w1} that represents a slight soiling of the items to be washed and/or washing water present in the dishwasher. This occurs, by preference, in or by way of the program control system for controlling the dishwasher. It is also conceivable, however, for the comparison to be performed in the sensor itself or in another functional group of the dishwasher or of the dispenser.

If a degree of soiling VG that meets the condition VG≦R_{w1} exists, the temperature of the washing water is held, at least in the cleaning program (RG), on average at ≦65° C., preferably ≦50° C., particularly preferably ≦40° C., and at the end of the cleaning program (RG) and/or of the last intermediate rinse cycle (ZG), at least rinse aid preparation is delivered out of the dispenser into the interior of the dishwasher, and the drying program immediately follows the cleaning program (RG) and/or the intermediate rinse cycle (ZG), without execution of a rinse aid program (KS).

It is particularly preferred that at least the rinse aid preparation be delivered out of the dispenser into the interior of the dishwasher during the last third of the cleaning program (RG).

Depending on the configuration of the washing program, it may also be advantageous for at least rinse aid preparation to be delivered out of the dispenser into the interior of the dishwasher during the last third of the final intermediate rinse (ZG).

According to a further, advantageous embodiment of the invention, the temperature inside the dishwasher in the drying program is held, on average, at ≦65° C., preferably ≦50° C., and particularly preferably ≦40° C.

It is most preferred that the temperature inside the dishwasher in the drying program be held, on average, to no more than 25%, preferably 17%, and particularly preferably 10% above the temperature of the washing water in the cleaning program (RG).

It is particularly advantageous that the temperature inside the dishwasher during the drying program be on average equal to, or at least no higher than, the temperature of the washing water in the cleaning program (RG).

It is further preferable that the drying program last less than 30 min, preferably less than 20 min, particularly preferably less than 10 min.

Preferably between 1 and 10 ml, preferably between 1.5 and 5 ml, particularly preferably between 2 and 4 ml of rinse aid preparation, having a surfactant content of between 1 and 50 vol %, is delivered out of the dispenser into the interior of the dishwasher.

Dispenser

The dispensing system according to the invention is made up of the basic components of a cartridge filled with preparation, and a dispenser couplable to the cartridge.

It is preferred that the dispensing system according to the present invention be movable. For purposes of this Application, “movable” means that the dispensing system is not nondetachably connected to a dishwasher, but instead is removable, for example, from a dishwasher or positionable in an dishwasher by the user, i.e. can be handled independently.

According to an alternative embodiment of the invention, it is also conceivable for the dispenser to be connected, nondetachably for the user, to a dishwasher, and for only the cartridge to be movable.

It is particularly preferred that the dispenser include at least a first interface that interacts with a corresponding interface configured in or on a household appliance in such a way that a transfer of electrical energy and/or signals from the household appliance to the dispenser is effected.

In an embodiment of the invention, the interfaces are embodied by plug connectors. In a further embodiment, the interfaces can be embodied such that a wireless transfer of electrical energy and/or electrical and/or optical signals is brought about.

It is of course possible to provide only an interface for the transfer of signals or an interface for the transfer of electrical energy, or one interface for the transfer of signals and one interface for the transfer of electrical energy, respectively, or to provide an interface that is suitable for providing a transfer of both electrical energy and signals.

An interface of this kind can be embodied in particular in such a way that a wireless transfer of electrical energy and/or electromagnetic and/or optical signals is produced.

The wireless transfer of signals can be realized, for example, by radio transfer or by the transfer of light signals, in particular in the IR region.

In a further, advantageous embodiment, the dispenser for delivering at least one washing- and/or cleaning-agent preparation into the interior of a household appliance encompasses at least one optical transmitting unit, the optical transmitting unit being configured in such a way that signals from the transmitting unit are couplable into a cartridge couplable to the dispenser, and signals from the transmitting unit can be radiated into the surroundings of the dispenser. It is thereby possible to realize, by means of one optical transmitting unit, both signal transmission between the dispenser and, for example, a household appliance such as a dishwasher, and signal input into a cartridge.

The optical transmitting unit can be, in particular, an LED.

In an advantageous refinement of the invention, the dispenser can encompass at least one optical receiving unit. This makes it possible, for example, for the dispenser to be able to receive signals from an optical transmitting unit arranged in the household appliance.

In particular, the optical receiving unit on the dispenser can also be embodied in such a way that the signals couplable from the transmitting unit into a cartridge couplable to the dispenser are couplable out of the cartridge, and are detectable by the optical receiving unit of the dispenser.

The signals emitted by the transmitting unit into the surroundings of the dispenser can preferably represent information with regard to operating states or control instructions.

Cartridge

For purposes of the present Application, a “cartridge” is understood as a packaging means that is suitable for encasing or holding together at least one flowable, pourable or scatterable preparation, and is couplable to a dispenser in order to deliver at least one preparation.

In the simplest conceivable embodiment, the cartridge comprises a (preferably dimensionally stable) chamber for stocking a preparation. In particular, a cartridge can also encompass multiple chambers that are Tillable with compositions differing from one another.

It is advantageous for the cartridge to comprise at least one outlet opening which is arranged such that gravity-effected release of preparation from the cartridge can be brought about in the utilization position of the dispenser. No further conveying means are required for the release of preparation from the cartridge. As a result, the construction of the dispenser can be kept simple with low manufacturing cost. The use of conveying means such as, for example, pumps can also be omitted, with the result that the service life of a battery or rechargeable battery of the dispenser can be lengthened.

In a preferred embodiment of the invention, at least one second chamber is provided for receiving at least one second flowable or scatterable preparation, the second chamber comprising at least one outlet opening which is arranged such that a gravity-effected product release from the second chamber can be brought about with the dispenser in the utilization position. The arrangement of a second chamber is particularly advantageous when preparations that are not usually shelf-stable with one another, for example bleaching agents and enzymes, are stocked in the mutually separate chambers of the cartridge.

It is furthermore conceivable for more than two, in particular three to four chambers to be provided in and/or on a cartridge. In particular, one of the chambers can be configured to deliver volatile preparations, for instance a scent, into the surrounding environment.

The dispenser and the cartridge preferably have, in the state coupled to one another, a ratio of height to width to depth of between 5:5:1 and 50:50:1, particularly preferably approximately 10:10:1. The “slender” embodiment of the dispenser and the cartridge makes it possible in particular to position the device in the lower loading rack of a dishwasher in the receptacles provided for plates. This has the advantage that the preparations delivered from the dispenser travel directly into the washing bath and cannot adhere to other items to be washed.

Commercially available household dishwashers are usually designed so that provision is made to arrange larger items to be washed, for instance pans or large plates, in the lower rack of the dishwasher. In order to prevent the user from positioning the dispensing system, made up of the dispenser and the cartridge coupled to the dispenser, less than optimally in the upper rack, in an advantageous embodiment of the invention the dispensing system is dimensioned so as to enable positioning of the dispensing system only in the receptacles, provided therefor, of the lower rack. To this end, the width and height of the dispensing system can be selected to be, in particular, between 150 mm and 300 mm, particularly preferably between 175 mm and 250 mm.

It is also conceivable, however, to embody the dispensing unit in a cup or tub shape, with a substantially circular or square base outline.

The cartridge is embodied in particular for the reception of flowable washing or cleaning agents. Particularly preferably, a cartridge of this kind comprises a plurality of chambers for spatially separated reception of preparations of a washing or cleaning agent that each differ from one another. By way of example, but not exhaustively, some possible combinations for filling the chambers with different preparations are listed in TABLE 1.

TABLE 1
Exemplary Combinations of Chamber Contents

| Scenario | Chamber 1 | Chamber 2 | Chamber 3 | Chamber 4 |
|---|---|---|---|---|
| A | Alkaline cleaning | Enzymatic cleaning | — | — |
| | preparation | preparation | | |
| B | Alkaline cleaning | Enzymatic cleaning | Rinse aid | — |
| | preparation | preparation | | |
| C | Alkaline cleaning | Enzymatic cleaning | Rinse aid | Scent |
| | preparation | preparation | | |
| D | Alkaline cleaning | Enzymatic cleaning | Rinse aid | Disinfectant |
| | preparation | preparation | | preparation |
| E | Alkaline cleaning | Enzymatic cleaning | Rinse aid | Pretreat- |
| | preparation | preparation | | ment |
| | | | | preparation |

The cartridge usually has a total volumetric capacity of <5000 ml, in particular <1000 ml, preferably <500 ml, particularly preferably <250 ml, very particularly preferably <50 ml.

The chambers of a cartridge can have volumetric capacities that are identical to or different from one another. In the case of a configuration having two chambers, the ratio of chamber volumes is preferably 5:1, for a configuration having three chambers preferably 4:1:1, these configurations being suitable in particular for use in dishwashers.

As mentioned above, the cartridge preferably possesses three chambers. For use of a cartridge of this kind in a dishwasher, it is particularly preferred that one chamber contain an alkaline cleaning preparation, a further chamber an enzymatic preparation, and a third chamber a rinse aid, the volume ratio of the chambers being equal to approximately 4:1:1.

The chamber containing the alkaline cleaning preparation preferably has the largest volumetric capacity of the chambers that are present. The chambers that store an enzymatic preparation and/or a rinse aid preferably have approximately the same volumetric capacity.

Rinse Aid Preparation

The rinse aid preparation for use in the method according to the present invention encompasses at least one flowable preparation encompassing a surfactant component.

Anionic, nonionic, cationic, and/or amphoteric surfactants are suitable as a surfactant component, nonionic surfactants being preferred because of their foaming capability.

Anionic surfactants that can be used are, for example, those of the sulfonate and sulfate types. Possibilities as surfactants of the sulfonate type are, by preference, C₉₋₁₃ alkylbenzenesulfonates, olefinsulfonates, i.e. mixtures of alkene- and hydroxyalkanesulfonates, and disulfonates, for example such as those obtained from C₁₂₋₁₈ monoolefins having a terminal or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example by sulfochlorination or sulfoxidation with subsequent hydrolysis and neutralization. The esters of α-sulfo fatty acids (estersulfonates), e.g. the α-sulfonated methyl esters of hydrogenated coconut, palm kernel, or tallow fatty acids, are likewise suitable.

Further suitable anionic surfactants are sulfonated fatty acid glycerol esters. “Fatty acid glycerol esters” are to be understood as the mono-, di- and triesters, and mixtures thereof, that are obtained in the context of manufacture by esterification of a monoglycerol with 1 to 3 mol fatty acid, or upon transesterification of triglycerides with 0.3 to 2 mol glycerol. Preferred sulfonated fatty acid glycerol esters are the sulfonation products of saturated fatty acids having 6 to 22 carbon atoms, for example hexanoic acid, octanoic acid, decanoic acid, myristic acid, lauric acid, palmitic acid, stearic acid, or behenic acid.

Preferred alk(en)yl sulfates are the alkali, and in particular sodium, salts of the sulfuric acid semi-esters of the C₁₂₋₁₈ fatty alcohols, for example from coconut fatty alcohol, tallow fatty alcohol, lauryl, myristyl, cetyl, or stearyl alcohol, or the C₁₀ to C₂₀ oxo alcohols, and those semi-esters of secondary alcohols of those chain lengths. Also preferred are alk(en)yl sulfates of the aforesaid chain length that contain a synthetic straight-chain alkyl residue produced on a petrochemical basis, which possess a breakdown behavior analogous to those appropriate compounds based on fat-chemistry raw materials. For purposes of washing technology, the C₁₂ to C₁₆ alkyl sulfates and C₁₂ to C₁₅ alkyl sulfates, as well as C₁₄ to C₁₅ alkyl sulfates, are preferred. 2,3-Alkyl sulfates that can be obtained, for example, as commercial products of the Shell Oil Company under the name DAN®, are also suitable anionic surfactants.

The sulfuric acid mono esters of the straight-chain or branched C₇₋₂₁ alcohols ethoxylated with 1 to 6 mol ethylene oxide, such as 2-methyl-branched C₉₋₁₁ alcohols with an average of 3.5 mol ethylene oxide (EO) or C₁₂₋₁₈ fatty alcohols with 1 to 4 EO, are also suitable. Because of their high-foaming behavior they are used in cleaning agents only in relatively small quantities, for example in quantities from 1 to 5 wt %.

Other suitable anionic surfactants are also the salts of alkylsulfosuccinic acid, which are also referred to as sulfosuccinates or as sulfosuccinic acid esters and represent the monoesters and/or diesters of sulfosuccinic acid with alcohols, by preference fatty alcohols, and in particular ethoxylated fatty alcohols. Preferred sulfosuccinates contain C₈₋₁₈ fatty alcohol residues or mixtures thereof. Particularly preferred sulfosuccinates contain a fatty alcohol residue that is derived from ethoxylated fatty alcohols that, considered per se, represent nonionic surfactants (see below for description). Sulfosuccinates whose fatty alcohol residues derive from ethoxylated fatty alcohols having a restricted homolog distribution are, in turn, particularly preferred. It is likewise also possible to use alk(en)ylsuccinic acid having by preference 8 to 18 carbon atoms in the alk(en)yl chain, or salts thereof.

Soaps are particularly appropriate as further anionic surfactants. Saturated fatty acid soaps, such as the salts of lauric acid, myristic acid, palmitic acid, stearic acid, hydrogenated erucic acid and behenic acid, are suitable, as are soap mixtures derived in particular from natural fatty acids, e.g. coconut, palm-kernel, olive-oil, or tallow fatty acids.

The anionic surfactants, including the soaps, can be present in the form of their sodium, potassium, or ammonium salts and as soluble salts of organic bases such as mono-, di-, or triethanolamine. The anionic surfactants are preferably present in the form of their sodium or potassium salts, in particular in the form of the sodium salts.

The nonionic surfactants used are by preference alkoxylated, advantageously ethoxylated, in particular primary alcohols having by preference 8 to 18 carbon atoms and an average of 1 to 12 mol ethylene oxide (EO) per mol of alcohol, in which the alcohol residue can be linear or preferably methyl-branched in the 2-position, and/or can contain mixed linear and methyl-branched residues, such as those that are usually present in oxo alcohol residues. Particularly preferred, however, are alcohol ethoxylates having linear residues made up of alcohols of natural origin having 12 to 18 carbon atoms, e.g. from coconut, palm, tallow, or oleyl alcohol, and an average of 2 to 8 EO per mol of alcohol. The preferred ethoxylated alcohols include, for example, C₁₂₋₁₄ alcohols with 3 EO or 4 EO, C₉₋₁₁ alcohols with 7 EO, C₁₃₋₁₅ alcohols with 3 EO, 5 EO, 7 EO, or 8 EO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 5 EO. The degrees of ethoxylation indicated represent statistical averages, which can correspond to an integer or a fractional number for a specific product. Preferred alcohol ethoxylates exhibit a restricted distribution of homologs (narrow range ethoxylates, NRE). In addition to these nonionic surfactants, fatty alcohols with more than 12 EO can also be used. Examples of these are tallow fatty alcohol with 14 EO, 25 EO, 30 EO, or 40 EO.

Also usable as further nonionic surfactants are alkyl glycosides of the general formula RO(G)ₓ in which R signifies a primary straight-chain or methyl-branched aliphatic residue, in particular methyl-branched in the 2-position, having 8 to 22, by preference 12 to 18 carbon atoms, and G is the symbol which denotes a glycose unit having 5 or 6 carbon atoms, preferably glucose. The degree of oligomerization x, which indicates the distribution of monoglycosides and oligoglycosides, is any number between 1 and 10; x is preferably 1.2 to 1.4.

A further class of nonionic surfactants used in preferred fashion, which are used either as the only nonionic surfactant or in combination with other nonionic surfactants, are alkoxylated, preferably ethoxylated or ethoxylated and propoxylated, fatty acid alkyl esters, by preference having 1 to 4 carbon atoms in the alkyl chain.

Nonionic surfactants of the amine oxide type, for example N-cocalkyl-N,N-dimethylamine oxide and N-tallowalkyl-N,N-dihydroxyethylamine oxide, and the fatty acid alkanolamides, can also be suitable. The quantity of these nonionic surfactants is by preference equal to no more than that of the ethoxylated fatty alcohols, in particular no more than half thereof.

Further suitable surfactants are polyhydroxy fatty acid amides of formula (II):

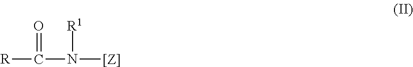

in which RCO denotes an aliphatic acyl residue having 6 to 22 carbon atoms; R¹ denotes hydrogen, an alkyl or hydroxyalkyl residue having 1 to 4 carbon atoms; and [Z] denotes a linear or branched polyhydroxyalkyl residue having 3 to 10 carbon atoms and 3 to 10 hydroxyl groups. The polyhydroxy fatty acid amides are known substances that can usually be obtained by reductive amination of a reducing sugar with ammonia, an alkylamine, or an alkanolamine, and subsequent acylation with a fatty acid, a fatty acid alkyl ester, or a fatty acid chloride.

Also belonging to the group of the polyhydroxy fatty acid amides are compounds of formula (III):

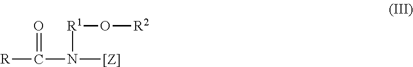

in which R denotes a linear or branched alkyl or alkenyl residue having 7 to 12 carbon atoms; R¹ denotes a linear, branched, or cyclic alkyl residue or an aryl residue having 2 to 8 carbon atoms; and R² denotes a linear, branched, or cyclic alkyl residue or an aryl residue or an oxyalkyl residue having 1 to 8 carbon atoms, C₁₋₄ alkyl or phenyl residues being preferred; and [Z] denotes a linear polyhydroxyalkyl residue whose alkyl chain is substituted with at least two hydroxyl groups, or alkoxylated, preferably ethoxylated or propoxylated, derivatives of that residue.

The residue [Z] is preferably obtained by reductive amination of a reduced sugar, for example glucose, fructose, maltose, lactose, galactose, mannose, or xylose. The N-alkoxy- or N-aryloxy-substituted compounds can be converted into the desired polyhydroxy fatty acid amides by reaction with fatty acid methyl esters in the presence of an alkoxide as catalyst.

Low-foaming nonionic surfactants are used as preferred surfactants. With particular preference, the utilization bath in step b) of the cleaning method according to the present invention contains nonionic surfactants, in particular nonionic surfactants from the group of alkoxylated alcohols. Alkoxylated, advantageously ethoxylated, in particular primary alcohols having preferably 8 to 18 carbon atoms and on average 1 to 12 mol of ethylene oxide (EO) per mol of alcohol, in which the alcohol residue can be linear or preferably methyl-branched in the 2-position and/or can contain linear and methyl-branched residues in the mixture, as are usually present in oxo alcohol residues, are preferably used as nonionic surfactants. In particular, however, alcohol ethoxylates having linear residues prepared from alcohols of natural origin with 12 to 18 carbon atoms, for example from coconut, palm, tallow fat or oleyl alcohol, and on average 2 to 8 mol of EO per mol of alcohol are preferred. Preferred ethoxylated alcohols include, for example, C₁₂₋₁₄ alcohols with 3 EO or 4 EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures of these, such as mixtures of C₁₂₋₁₄ alcohol with 3 EO and C₁₂₋₁₈ alcohol with 5 EO. The stated degrees of ethoxylation represent statistical averages which, for a specific product, may be an integer or a fractional number. Preferred alcohol ethoxylates have a narrow homolog distribution (narrow range ethoxylates, NRE). In addition to these nonionic surfactants, fatty alcohols with more than 12 EO may also be used. Examples of these are tallow fatty alcohol with 14 EO, 25 EO, 30 EO or 40 EO.

Cleaning methods according to the present invention in which the rinse aid preparation contains a nonionic surfactant that has a melting point of above room temperature are particularly preferred. Preferred cleaning methods are consequently characterized in that the rinse aid preparation contains nonionic surfactant(s) having a melting point above 20° C., by preference above 25° C., particularly preferably between 25 and 60° C., and in particular between 26.6 and 43.3° C.

Suitable nonionic surfactants that have melting and/or softening points in the aforesaid temperature range are, for example, low-foaming nonionic surfactants that can be solid or highly viscous at room temperature. If nonionic surfactants that are highly viscous at room temperature are used, it is then preferred that they have a viscosity above 20 Pa·s, by preference above 35 Pa·s, and in particular above 40 Pa·s. Nonionic surfactants that possess a waxy consistency at room temperature are also preferred.

Nonionic surfactants that are solid at room temperature and are preferred for use derive from the groups of the alkoxylated nonionic surfactants, in particular the ethoxylated primary alcohols, and mixtures of these surfactants with surfactants of greater structural complexity, such as polyoxypropylene/polyoxyethylene/polyoxypropylene (PO/EO/PO) surfactants. (PO/EO/PO) nonionic surfactants of this kind are moreover notable for good foam control.

In a preferred embodiment of the present invention, the nonionic surfactant having a melting point above room temperature is an ethoxylated nonionic surfactant that has resulted from the reaction of a monohydroxyalkanol or alkylphenol having 6 to 20 carbon atoms with by preference at least 12 mol, particularly preferably at least 15 mol, in particular at least 20 mol, ethylene oxide per mol of alcohol and/or alkylphenol.

A nonionic surfactant that is solid at room temperature and is particularly preferred for use is obtained from a straight-chain fatty alcohol having 16 to 20 carbon atoms (C₁₆₋₂₀ alcohol), by preference a C₁₈ alcohol, and at least 12 mol, by preference at least 15 mol, and in particular at least 20 mol ethylene oxide. Among these, the so-called “narrow range ethoxylates” (see above) are particularly preferred.

The nonionic surfactant that is solid at room temperature preferably additionally possesses propylene oxide units in the molecule. Such PO units constitute by preference up to 25 wt %, particularly preferably up to 20 wt %, and in particular up to 15 wt % of the total molar weight of the nonionic surfactant. Particularly preferred nonionic surfactants are ethoxylated monohydroxyalkanols or alkylphenols that additionally comprise polyoxyethylene-polyoxypropylene block copolymer units. The alcohol and/or alkylphenol portion of such nonionic surfactant molecules constitutes by preference more than 30 wt %, particularly preferably more than 50 wt %, and in particular more than 70 wt % of the total molar weight of such nonionic surfactants. Preferred cleaning methods are characterized in that the utilization bath in step b) contains ethoxylated and propoxylated nonionic surfactants in which the propylene oxide units in the molecule account for up to 25 wt %, preferably up to 20 wt %, and in particular up to 15 wt % of the total molar weight of the nonionic surfactant.

Further nonionic surfactants having melting points above room temperature that are particularly preferred for use contain 40 to 70% of a polyoxypropylene/polyoxyethylene/polyoxypropylene block polymer blend that contains 75 wt % of a reverse block copolymer of polyoxyethylene and polyoxypropylene with 17 mol ethylene oxide and 44 mol propylene oxide, and 25 wt % of a block copolymer of polyoxyethylene and polyoxypropylene, initiated with trimethylolpropane and containing 24 mol ethylene oxide and 99 mol propylene oxide per mol of trimethylolpropane.

Nonionic surfactants that can be used with particular preference are obtainable, for example, from Olin Chemicals under the name Poly Tergent® SLF-18.

A further preferred cleaning method according to the present invention is characterized in that the rinse aid preparation contains nonionic surfactants of the formula,

R¹O[CH₂CH(CH₃)O]ₓ[CH₂CH₂O]_{y}[CH₂CH(OH)R²]

in which R¹ denotes a linear or branched aliphatic hydrocarbon residue having 4 to 18 carbon atoms or mixtures thereof, R² denotes a linear or branched hydrocarbon residue having 2 to 26 carbon atoms or mixtures thereof, and x denotes values between 0.5 and 15 and y denotes a value of at least 15.

Further nonionic surfactants that are preferred for use are the end-capped poly(oxyalkylated) nonionic surfactants of the formula,

R¹O[CH₂CH(R³)O]ₓ[CH₂]ₖCH(OH)[CH₂]ⱼOR²

in which R¹ and R² denote linear or branched, saturated or unsaturated, aliphatic or aromatic hydrocarbon residues having 1 to 30 carbon atoms; R³ denotes H or a methyl, ethyl, n-propyl, isopropyl, n-butyl, 2-butyl, or 2-methyl-2-butyl residue; x denotes values between 1 and 30; and k and j denote values between 1 and 12, by preference between 1 and 5. If the value of x is greater than or equal to 2, each R³ in the above formula can be different. R¹ and R² are by preference linear or branched, saturated or unsaturated, aliphatic or aromatic hydrocarbon residues having 6 to 22 carbon atoms, residues having 8 to 18 carbon atoms being particularly preferred. For the R³ residue, H, —CH₃, or —CH₂CH₃ are particularly preferred. Particularly preferred values for x are in the range from 1 to 20, in particular from 6 to 15.

As described above, each R³ in the formula above can be different if x≧2. The alkylene oxide unit within square brackets can thereby be varied. If, for example, x denotes 3, the R³ residue can be selected so as to form ethylene oxide units (R³═H) or propylene oxide (R³═CH₃) units, which can be joined to one another in any sequence, for example (EO)(PO)(EO), (EO)(EO)(PO), (EO)(EO)(EO), (PO)(EO)(PO), (PO)(PO)(EO), and (PO)(PO)(PO). The value of 3 for x was selected here as an example, and can certainly be larger; the range of variation increases with rising values of x, and includes, for example, a large number of (EO) groups combined with a small number of (PO) groups, or vice versa.

Particularly preferred end-capped poly(oxyalkylated) alcohols of the above formula have values of k=1 and j=1, so that the formula above is simplified to the general formula, R¹O[CH₂CH(R³)O]ₓCH₂CH(OH)CH₂OR².

In the latter formula, R¹, R², and R³ are as defined above, and x denotes numbers from 1 to 30, by preference from 1 to 20, and in particular from 6 to 18. Surfactants in which the R¹ and R² residues have 9 to 14 carbon atoms, R³ denotes H, and x assumes values from 6 to 15, are particularly preferred.

In summary, cleaning methods according to the present invention in which the rinse aid preparation contains end-capped poly(oxyalkylated) nonionic surfactants of the formula,

R¹O[CH₂CH(R³)O]_{X}[CH₂]ₖCH(OH)[CH₂]ⱼOR²

in which R¹ and R² denote linear or branched, saturated or unsaturated, aliphatic or aromatic hydrocarbon residues having 1 to 30 carbon atoms; R³ denotes H or a methyl, ethyl, n-propyl, isopropyl, n-butyl, 2-butyl, or 2-methyl-2-butyl residue; x denotes values between 1 and 30, and k and j denote values between 1 and 12, preferably between 1 and 5, are preferred. Surfactants of the type represented by R¹O[CH₂CH(R³)O]ₓCH₂CH(OH)CH₂OR², in which x denotes numbers from 1 to 30, preferably from 1 to 20, and in particular from 6 to 18, are particularly preferred.

Further exemplifying embodiments of the invention will now be explained with reference to the drawing figures.

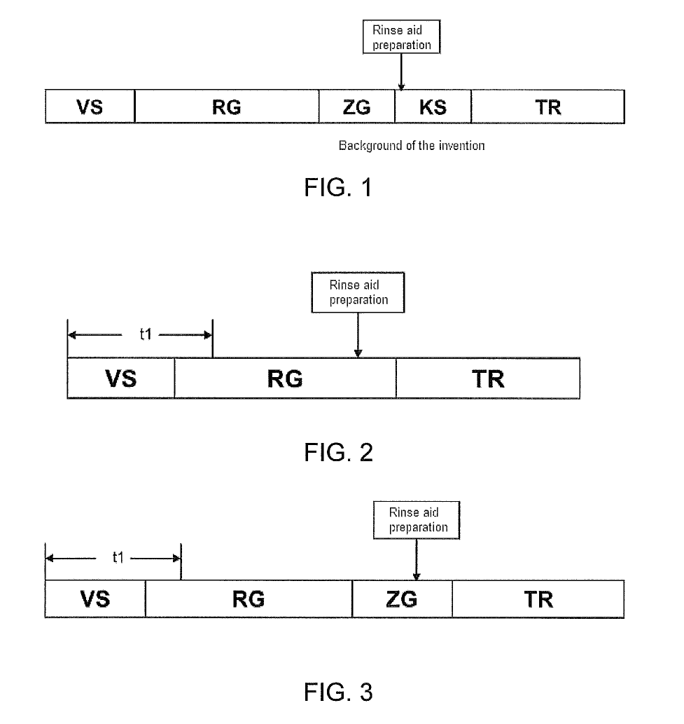

FIG. 1 shows a typical cleaning program sequence as known from the existing art. A washing program usually begins with a pre-wash program (VS), followed by a cleaning cycle (RG). Depending on the washing program selected, or on the degree of soiling, the cleaning cycle (RG) can be followed by an intermediate rinse cycle (ZG). The washing program ends with a rinse aid program (KS), at the beginning of which, or after a specific temperature level has been exceeded, a rinse aid preparation is released; and with a drying program (TR).

FIG. 2 shows a first embodiment of the washing program according to the present invention. It is evident that in contrast to the method known from the existing art, the release of rinse aid preparation occurs already in the cleaning program (RG). The release occurs preferably in the last third of the cleaning program (RG). The cleaning program (RG) is followed immediately, without interposition of a rinse program (KS), by the drying program (TR).

As is evident from FIG. 3, the release of rinse aid preparation can also occur in a final intermediate rinse program, if an intermediate rinse program (ZG) is provided in the washing program.

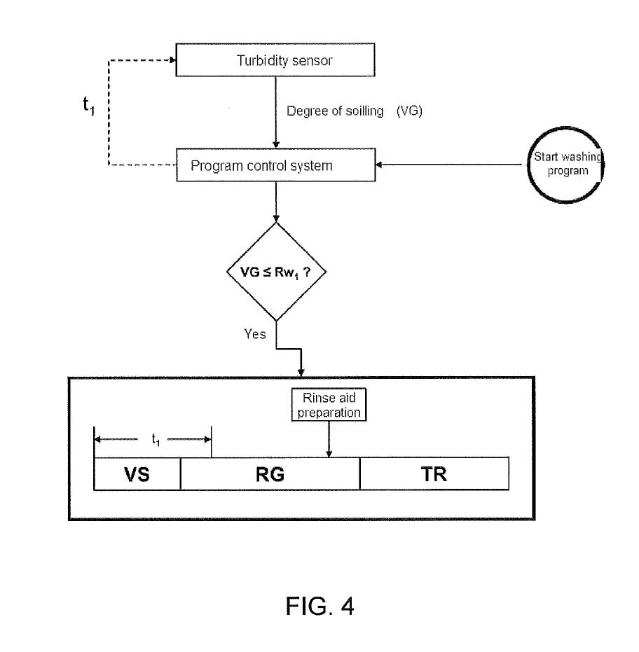

The method sequence is explained in further detail below with reference to FIG. 4. At the start of the washing program, the program control system authorizes, at least one point in time t₁, determination of the degree of soiling (VG) by means of a turbidity sensor. The point in time t₁ is located in time in or before the first third of the cleaning program (RG). The point in time t₁ is preferably located within the pre-wash program (VS), very particularly preferably in the first third of the pre-wash program (VS). This is also indicated by the time interval t₁ depicted in FIG. 2 and FIG. 3.

After determination of the degree of soiling (VS) at point in time t₁, the measured degree of soiling (VS) is compared with a reference value R_{w1} that represents slight soiling of the items to be washed and/or of the washing water present in the dishwasher. If the degree of soiling (VG) is less than or equal to the reference value R_{w1}, subsequent execution of a rinse aid program in the washing program is omitted, as sketched in FIG. 2 and FIG. 3, rinse aid preparation then being released in the cleaning program (RG) and/or intermediate rinse program (ZG).

When a slight soiling is present in the case of a measurement of the degree of soiling (VS) in the pre-washing program and comparison with the reference value R_{w1}, a decision can also be made to transition immediately, without a water change, into the cleaning cycle (RG).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A method for operating an automatic dishwasher, said method comprising the steps of:
a. providing a dispenser permanently installed in the dishwasher or movably positioned in the interior of the dishwasher, said dispensing having a cartridge comprising a plurality of chambers, each of said chambers containing different preparations, wherein at least one of the chambers includes a liquid rinse aid preparation;
b. providing a program control system for controlling the dishwasher, wherein at least one washing program comprises: a cleaning program (RG); an intermediate rinse program (ZG); a drying program (TR); a rinse aid program (KS); and optionally, a pre-wash program (VS);
c. providing at least one sensor for determining the degree of soiling on the items to be washed or the degree of soiling in the washing water present in the dishwasher;
d. determining the degree of soiling VG at least once at the beginning of the washing program at a point in time t₁;
e. comparing the measured degree of soiling VG with a reference value R_{w1} that represents a slight soiling of the items to be washed and/or slight soiling in the washing water present in the dishwasher; and
wherein if the degree of soiling VG is less than or equal to said reference value R_{w1}, then:
iv. holding the temperature of the washing water at least during the cleaning program (RG) on average at ≦65° C.;
v. delivering said liquid rinse aid preparation from the dispenser into the interior of the dishwasher at the end of the cleaning program (RG) and/or at the end of the intermediate rinse cycle (ZG); and
vi. executing the drying program (TR) immediately following the cleaning program (RG) and/or the intermediate rinse cycle (ZG) without execution of the rinse aid program (KS).

2. The method of claim 1, wherein said point in time t₁ is before or at the beginning of the cleaning program (RG).

3. The method of claim 1, wherein the temperature of the washing water is held on average at ≦50° C. if the degree of soiling VG is less than or equal to said reference value R_{w1}.

4. The method of claim 1, wherein said temperature of the washing water is held on average at ≦40° C. if the degree of soiling VG is less than or equal to said reference value R_{w1}.

5. The method of claim 1, wherein the rinse aid preparation is delivered out of the dispenser into the interior of the dishwasher in a last third of the cleaning program (RG).

6. The method of claim 1, wherein at least rinse aid preparation is delivered out of the dispenser into the interior of the dishwasher in a last third of the intermediate rinse cycle (ZG).

7. The method of claim 1, wherein the temperature inside the dishwasher during the drying program (TR) is held, on average, at ≦65° C.

8. The method of claim 7, wherein said temperature is held on average, at ≦40° C.

9. The method of claim 1, wherein the temperature inside the dishwasher during the drying program (TR) is, on average, no more than 25% above the temperature of the washing water during the cleaning program (RG).

10. The method of claim 9, wherein said temperature is, on average, no more than 10% above the temperature of the washing water during the cleaning program (RG).

11. The method of claim 1, wherein the temperature inside the dishwasher during the drying program (TR) is, on average, equal to, or at least no higher than, the temperature of the washing water during the cleaning program (RG).

12. The method of claim 1, wherein the drying program (TR) lasts less than 30 min.

13. The method of claim 12, wherein the drying program (TR) lasts less than 20 min.

14. The method of claim 13, wherein the drying program (TR) lasts less than 10 min.

15. The method of claim 1, wherein said rinse aid preparation comprises a surfactant content of 1-50 vol %, and wherein between 1 and 10 ml of said rinse aid preparation is delivered out of the dispenser into the interior of the dishwasher.

16. The method of claim 15, wherein said surfactant is chosen from the group consisting of anionic surfactants, nonionic surfactants, cationic surfactants, amphoteric surfactants, and mixtures thereof.

17. The method of claim 1, wherein said program control system is provided in the dispenser and/or in the dishwasher.

18. The method of claim 1, wherein said sensor is configured in the dispenser or in the dishwasher.

19. The method of claim 1, wherein said sensor is a turbidity sensor.
